(19) United States
(12) Patent Application Publication
(10) Pub. No.: US 2013/0052625 A1
(43) Pub. Date: Feb. 28, 2013

(54) Method for producing a set of dental appliances for correcting tooth misalignments and orthodontic set-up model therefor

(71) Applicant: Carsten Wagner, Bretten (DE)

(72) Inventor: Carsten Wagner, Bretten (DE)

(21) Appl. No.: 13/599,963

(22) Filed: Aug. 30, 2012

(30) Foreign Application Priority Data
Aug. 31, 2011 (DE) 10 2011 053 151.3

(51) Int. Cl. A61C 7/08; B29C 51/00; G09B 23/30

(52) U.S. Cl. 434/263; 264/16

(57) ABSTRACT

The invention relates to a method for producing a set of shell appliances for correcting tooth misalignments in a patient, wherein a target position is established from a current position of the patient's teeth, models of the patient's individual teeth or of groups of the patient's teeth are produced and can be arranged on a support to form a model of a set of teeth. In accordance with the invention, a set of supports is produced, which have a respective fitting position for each of the tooth models, the position and alignments of said fitting positions predefining a position of the tooth model, wherein the positions predefined by the supports form a sequence that leads in steps to the target position, and the tooth models are fitted in succession onto the individual supports, thus producing a respective model of a set of teeth, and a shell appliance is produced from each of these models of a set of teeth by thermoforming.

The invention relates to a method for producing a set of dental appliances for correcting tooth misalignments in a patient.

It is known from U.S. Pat. No. 7,357,636 B2 that transparent polymeric shell appliances can be used as an alternative to metal-wired brackets or braces to correct tooth misalignments. The tooth movements that can be achieved with a single shell appliance are very limited. To treat a tooth misalignment, a set of approximately 10 to 50 shell appliances is therefore typically required, which are worn in succession for a few days or weeks in each case. Each shell appliance of such a set is used for a treatment step, at the end of which the teeth have reached an intermediate position that is slightly closer to the desired target position than the position at the start of the treatment step. The target position of the patient's teeth is then finally reached with the last shell appliance in the set.

Braces of this type for correcting tooth misalignments can be produced from transparent plastics material, and therefore they are practically invisible compared to metal-wired brackets or braces. For this reason, many patients opt for treatment of tooth misalignments using a set of transparent shell appliances made of plastics material.

It is known from U.S. Pat. No. 7,357,636 B2 to produce a set of polymeric shell appliances for correcting tooth misalignments by first producing a model of a set of teeth for a patient, in which the teeth are individually movable with respect to a support that simulates the jaw. The model of a set of teeth contains micro-actuators with which the teeth on the support can be brought into the positions that are desired in an intermediate step of the treatment process and for which a shell appliance is consequently required. In each of these teeth positions, a shell appliance is then produced with the model by means of thermoforming. By bringing the teeth in the model into the desired positions in succession, all appliances within a set for correcting tooth misalignments can be produced with this model by thermoforming.

This production method signifies great ease compared to conventional methods, in which a plaster model of a patient's teeth is cut up and the individual teeth are then arranged by hand in the desired positions using a modelling compound.

### SUMMARY OF THE INVENTION

The object of the present invention is to present a way of further reducing the costs for producing a set of shell appliances for correcting tooth misalignments.

This object is achieved by a method having the features disclosed in Claim 1. Advantageous refinements of the invention are disclosed in the dependent claims.

With a method according to the invention, a target position that is to be reached as a result of orthodontic treatment using plastics material shell appliances is established from a current position of a patient's teeth. The current position of the teeth can be established for example using an imprint or by x-ray scan. The target position can be calculated from digital data concerning the current position. It is also possible, however, for the target position to be predefined by an orthodontist or by an experienced technician by predefining a target position based on experience or based on patient wishes.

In a further step, tooth models of the patient's individual teeth or of groups of the patient's teeth are produced and can be arranged on a support to form a model of a set of teeth. Instead of using just a single support, on which the tooth models can be moved by means of micro-actuators and are brought into a desired position to produce each individual shell appliance, in accordance with the invention a set of supports is produced, which are then used for the production of a respective shell appliance. Each of the supports has a fitting position for each of the tooth models, the position and alignment of the fitting positions predefining a position of the relevant tooth model. By fitting the tooth models into the fitting positions in a support, a model of a set of teeth is thus produced, in which the teeth positions correspond to a desired positioning of the teeth in a treatment step. The model of a set of teeth produced by fitting the tooth models on a support is then used to produce a plastics material shell appliance by thermoforming.

The positions predefined by the individual supports within the set form a sequence that leads to the target position in steps. By fitting the tooth models successively onto the individual supports, a respective model of a set of teeth is produced and a shell appliance is produced from each of these models of a set of teeth by thermoforming.

The outlay of the method according to the invention is relatively low, since the tooth models only have to be produced once and can be used with each of the supports so as to form, in succession, the models of a set of teeth required for production of the shell appliances. The individual supports can be produced cost effectively, for example as plates with holes, into which the tooth models can be fitted. The positions of the tooth models can be accurately predefined by the position and orientation of the holes. The manufacturing outlay of a set of supports of this type is much lower than the production outlay of a support with micro-actuators for moving the individual teeth. In addition, problems associated with possible failures or faults of micro-actuators can be avoided, since the models of a set of teeth according to the invention are produced without the use of machinery and electronic equipment that is susceptible to failure.

A further advantage of the present invention is that a replacement shell appliance can be produced with minimal effort, for example if an individual shell appliance is lost or damaged by a patient. The corresponding support and the tooth models are easily assembled again and the model of a set of teeth thus produced is used to produce a further shell appliance by thermoforming. In a complex model with micro-actuators, this is not possible so easily, however, since, for economic reasons, the micro-actuators have to be used to produce shell appliances for many patients. This means that a model of a set of teeth produced for a patient has to be disassembled again once a set of shell appliances has been produced. Although in theory it is possible to re-assemble the tooth models on a support with micro-actuators if necessary, this is much more involved compared to simply fitting tooth models according to the invention on a support in accordance with the method according to the invention.

For the method according to the invention, a tooth model can be produced for each of a patient's individual teeth. It is also possible, however, to produce a tooth model for a number of teeth, that is to say a group of teeth. This approach lends itself if the relative position between certain adjacent teeth does not have to be corrected. In this case, two or three adjacent teeth for example may be combined to form one tooth model. This simplifies fitting of the tooth models on a support, since fewer tooth models have to be fitted. In addition, production of the supports is also thus simplified, since fewer fitting positions are required.

The fitting positions can be easily predefined by holes, into which protrusions of the models, for example pins, fit. The holes can be inclined differently so as to predefine a desired inclination of a tooth model. The inclinations of the holes in different fitting positions in a support may differ and thus predefine different inclinations of the individual tooth models. However, it is just as important that the inclinations of a fitting position in the various supports within a set may also differ. Shell appliances can thus be produced that then change the inclination of the teeth during orthodontic treatment.

If the holes are formed as blind holes, the base of the blind hole may advantageously be used as a stop and may predefine how far the protrusion of a model can be fitted into the hole. The relative height of the tooth models to one another can thus also be predefined, for example if individual teeth are to be pressed deeper into the jaw during treatment by the shell appliances produced.

In a fitting position, a stop that defines how far a protrusion of the model to be matched to the fitting position can be fitted into the support may also be formed by a stop face for example, which surrounds a hole for fitting of a protrusion of a model. In this case, the tooth model also has a stop, for example the underside of a model of the crown of a tooth. The model of the crown may be arranged on a protrusion, for example in the form of a pin. The stop face of the support can be formed for example as an elevation, a socket or may simply be the surface of the support.

Any holes in the support used in accordance with the invention can be elongate holes or may have another cross-section differing from the circular form. The tooth models can thus advantageously be prevented from rotating on the support. For example, a groove and spring connection may be formed with an elongate hole by forming the protrusion of the tooth model as a spring.

It is particularly simple if the holes are formed as cylindrical holes. Holes can be produced in a support with little effort in desired orientations and at desired depths.

The protrusions of the individual models can be formed as pins, which fit into the holes. Pins having a cylindrical cross-section can be produced cost effectively or can be obtained cost effectively as standard parts. Models of the crowns of the teeth can be fitted onto the pins, thus producing the required tooth models.

If the fitting positions of the support are formed as cylindrical holes, it is advantageous if each fitting position has at least two holes and each of the tooth models accordingly has at least two pins. More specifically, if a tooth model having two pins is fitted into two holes, said tooth model can no longer rotate on the support. It is particularly advantageous if a fitting position is defined by at least two holes having different diameters, since a tooth model can then only be fitted on the support in a single orientation. A source of error when producing a model of a set of teeth by fitting the tooth models onto the support can thus be ruled out.

In accordance with an advantageous refinement of the invention, gaps between the tooth models once fitted onto a support can be filled before a shell appliance is produced by thermoforming. For example, gaps between the tooth models are filled using a filler material like a paste or a powder. Filling gaps makes it possible to increase user comfort when wearing the subsequently produced shell appliance and to simplify production thereof. Even if gaps between the individual tooth models correspond to the desired state of the teeth in an intermediate step of the treatment process, it is better if the shell appliance does not reproduce areas between teeth in a detailed manner, since the shell appliance can then be fitted more easily onto the patient's teeth. Filling gaps with a paste, a powder or the like does not require much effort and does not conflict with multiple use of the tooth models.

A further aspect of the present invention concerns an orthodontic set-up model consisting of tooth models of a patient's individual teeth or of groups of a patient's teeth and a support, which has a fitting position for each of the tooth models, said fitting positions being defined by one or more holes, preferably blind holes, into which a respective protrusion of the tooth models fits. Such a set-up model is a model of a set of teeth, which is produced with the method according to the invention and in which tooth models are fitted on a support.

To produce a set of transparent plastics material shell appliances for correcting tooth misalignments in a patient, a series of orthodontic set-up models of this type having a series of supports is used, which can be supplemented by fitting the tooth models successively into the fitting positions provided therefor in one of the supports to form models of a set of teeth, wherein the tooth positions within the models of a set of teeth represent planned intermediate steps of the tooth positions of a patient during orthodontic treatment.

### BRIEF DESCRIPTION OF THE DRAWINGS

Further details and advantages of the invention will be explained on the basis of embodiments with reference to the accompanying drawings. Like and corresponding parts are denoted by matching reference numbers. In the drawings:

FIG. 1 shows the current position of a patient's teeth;

FIG. 2 shows a tooth model of one of the patient's teeth;

FIG. 3 shows a support with fitting positions for tooth models;

FIG. 4 shows a model of a set of teeth with the support shown in FIG. 3 and tooth models fitted thereon;

FIG. 5 shows a further view of FIG. 4;

FIG. 6 shows a further support with fitting positions; and

FIG. 7 shows a model of a set of teeth with the support shown in FIG. 6 and tooth models fitted thereon.

FIG. 8 shows plastics material shell appliances produced by thermoforming with a model of a set of teeth.

### DETAILED DESCRIPTION

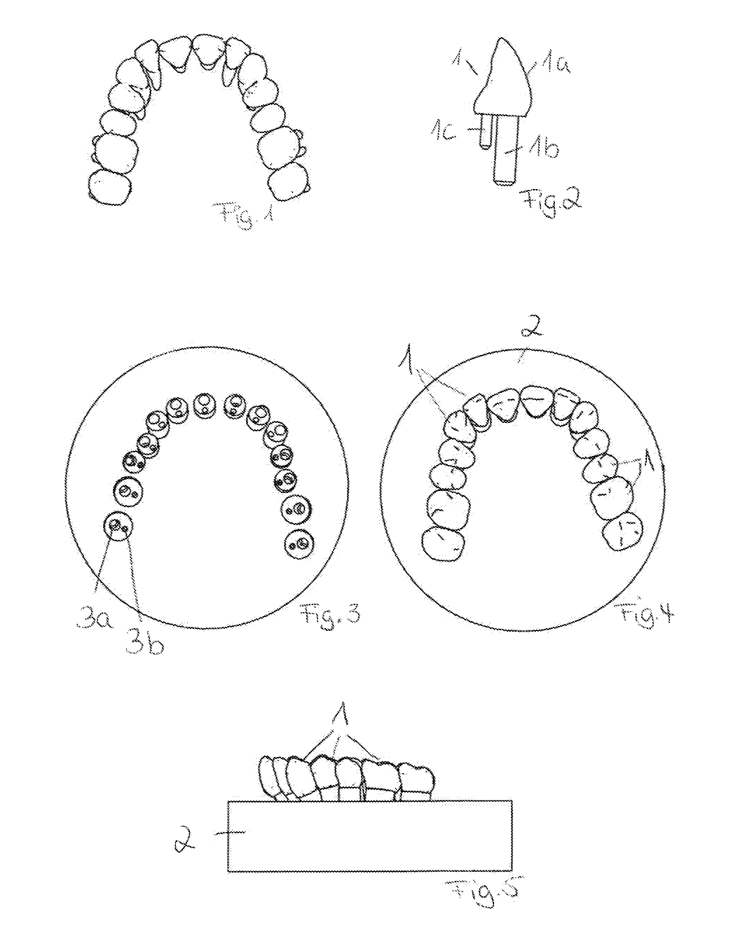

FIG. 1 shows a schematic illustration of a patient's teeth in a current position, before starting orthodontic treatment. To correct tooth misalignments, the current position of the patient's teeth is first established, for example using a dental imprint or by x-ray. The data thus obtained regarding the patient's teeth can be digitalised and used to calculate a target position, which constitutes a desired result of the orthodontic treatment. However, a target position may also be predefined for example by an orthodontist or an experienced dental technician.

Only a small correction to a tooth misalignment can generally be achieved using a single plastics material shell appliance 5. For orthodontic treatment, a whole set of shell appliances 5 is therefore necessary, said shell appliances being used in succession and each carrying out a correction step toward the target position. The intermediate positions desired during treatment, for each of which a respective shell appliance 5 has to be produced, can be calculated from the current position of the patient's teeth at the start of the treatment process and from the desired target position. It is also possible, however, for the intermediate positions to be defined based on experience by an orthodontist or by a dental technician.

To produce the plastics material shell appliances 5 for correcting teeth, tooth models 1 of the patient's teeth are first produced. An example of such a tooth model 1 is illustrated in FIG. 2. The tooth model 1 has an upper part 1a, which simulates the crown of the tooth. The upper part 1a of the tooth model 1 sits on a protrusion, for example on one or more pins 1b, 1c. In the illustrated exemplary embodiment, the model of the tooth crown is fastened to two pins 1b, 1c. These two pins 1b, 1c are preferably cylindrical and have different diameters, as is the case in the illustrated embodiment.

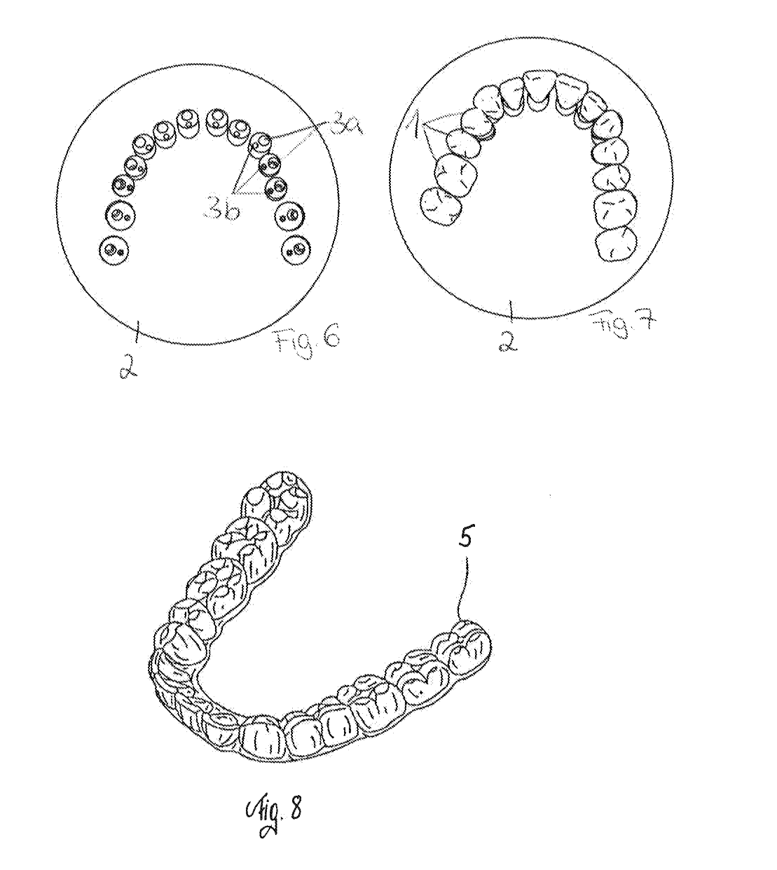

A support 2 is produced for each shell appliance 5 to be produced and has fitting positions for the individual tooth models 1. An illustrative embodiment of such a support 2 is illustrated in FIG. 3. The fitting positions in the support 2 are defined by holes 3a, 3b, into which the pins 1b, 1c of the tooth models 1 fit. The position and inclination of the holes 3a, 3b predefine the position and inclination of the individual tooth models 1. At least one of the holes 3a, 3b of a fitting position is preferably a blind hole (3a, 3b), and therefore the height at which the upper part 1a or the crown of a tooth model 1 fitted into the support 2 is arranged is also predefined by the depth of the blind holes. A support 2 with tooth models 1 forms an orthodontic set-up model. By fitting the tooth models 1 into the fitting positions of the support 2, a model of a set of teeth is produced, as illustrated in FIGS. 4 and 5 in different views. The support 2 may be a simple plate with holes 3a, 3b for example, and can therefore be produced cost effectively.

The individual tooth models 1 can be provided with a marking, for example a number, which indicates the patient's tooth to which the tooth model 1 corresponds. In particular, the marking can predefine the fitting position of a support 2 into which the relevant tooth model 1 is to be fitted.

The support 2 may have a raised socket 4 for each of the individual tooth models 1, in which the holes 3a, 3b are located into which the pins 1b, 1c of the tooth models 1 are fitted. The sockets 4 may be provided as elevations that have different heights and may be inclined differently, that is have differently inclined top surfaces. The sockets 4 may form a stop, against which a tooth model 1 lies via a contact face, for example the underside of its upper part 1a. The tooth models 1 are then mechanically supported particularly well in their positions. Sockets 4 can also be omitted, however, so as to simply fabrication of the supports 2. Mechanically reliable positioning of the tooth models 1 can be achieved merely by the cooperation of holes 3a, 3b and pins 1b, 1c.

The model of a set of teeth produced by fitting the tooth models 1 on a support 2 is then used as a thermoforming mould so as to produce a transparent plastics material shell appliance 5, as illustrated schematically in FIG. 8. It may be advantageous to fill gaps between the individual tooth models 1 and/or between the lower edge of the upper parts 1a or crowns of the tooth models 1 and the support 2, for example using a powder or a paste.

To produce a set of shell appliances 5 for correcting tooth misalignments in a patient, a set of supports 2 is produced. The set consists of a plurality of different supports 2, for example 10 to 50 supports 2. The individual supports 2 within a set differ with regard to their fitting positions, namely with regard to the position of the fitting positions relative to one another and/or the orientation of the fitting positions. The fitting positions in each support 2 predefine a respective tooth position, which is desired as an intermediate step or as an end step of an orthodontic treatment process. An exemplary embodiment of a further support 2 is illustrated in FIG. 6. As can be seen, the fitting positions in this support 2 are arranged slightly differently compared to those in the support 2 illustrated in FIG. 3. By fitting the tooth models 1 on the support 2 illustrated in FIG. 6, a model of a set of teeth is therefore produced, in which the position of the teeth is slightly closer to the desired target position. This model of a set of teeth is illustrated in FIG. 7.

### REFERENCE NUMBERS

1 tooth model
1a upper part
1b pin
1c pin
2 support
3a hole
3b hole
4 elevated socket
5 plastics material shell appliance

What is claimed is:

1. A method for producing a set of shell appliances for correcting tooth misalignments in a patient, comprising
establishing a target position from a current position of the patient's teeth, producing models of the patient's individual teeth or of groups of the patient's teeth that can be arranged on a support to form a model of a set of teeth,
wherein a set of such supports is produced, which have a respective fitting position for each of the tooth models, the position and alignments of said fitting positions predefining a position of the tooth model, the positions predefined by the supports forming a sequence that leads in steps to the target position, and
wherein the tooth models are fitted in succession onto the individual supports, thus producing with each support a model of a set of teeth, and
wherein a polymeric shell appliance is produced from each of these models of a set of teeth by thermoforming.

2. The method according to claim 1, wherein the fitting positions are defined by holes, into which protrusions of the tooth models fit, said holes being inclined differently.

3. The method according to claim 1, wherein each fitting position provides a stop, which defines how far a protrusion of the tooth model to be matched to the fitting position can be fitted into the support.

4. The method according to claim 3, wherein each fitting position has at least one blind hole and the stop is formed as the bottom of the blind hole.

5. The method according to claim 1, wherein gaps between the tooth models are filled once fitted onto a support before a shell appliance is produced by thermoforming.

6. The method according to claim 5, wherein the gaps are filled with a paste or a powder.

7. An orthodontic set-up model consisting of models of a patient's individual teeth or of groups of a patient's teeth and a support that has a fitting position for each of the tooth models, said fitting position being defined by one or more holes into which a respective protrusion of the tooth models fits.

8. The orthodontic set-up model according to claim 7, wherein the support is a plate.

9. The orthodontic set-up model according to claim 7, wherein the holes are blind holes.

10. The orthodontic set-up model according to claim 7, wherein the support has raised sockets, in which the holes are located.

11. The orthodontic set-up model according to claim 7, wherein the holes are cylindrical bores.

12. Orthodontic set-up according to claim 11, wherein each tooth model has at least two pins as the protrusion, said pins fitting into matching bores in the support.

13. Orthodontic set-up model according to claim 12, wherein the two pins have different diameters.

14. A series of orthodontic set-up models according to claim 7, comprising a series of supports, which can be supplemented by fitting the tooth models successively into the fitting positions provided therefor in one of the supports to form models of a set of teeth, wherein the teeth positions within the models of a set of teeth represent planned intermediate steps of the positions of a patient's teeth during orthodontic treatment.
